(19) United States
(12) Patent Application Publication
(10) Pub. No.: US 2012/0091976 A1
(43) Pub. Date: Apr. 19, 2012

(54) BOOTSTRAP CIRCUIT WITHOUT A REGULATOR OR A DIODE

(76) Inventors: Chi-Ming Chen, Hsin-Chu (TW); Chung-Ming Hsieh, Hsin-Chu (TW)

(21) Appl. No.: 12/954,670

(22) Filed: Nov. 25, 2010

(30) Foreign Application Priority Data
Oct. 19, 2010 (TW) 099135587

(51) Int. Cl. G05F 1/00

(52) U.S. Cl. 323/271

(57) ABSTRACT

A bootstrap circuit without a regulator and a diode includes a comparator, a first switch, and a capacitor. The comparator has a first terminal for receiving a reference voltage, a second terminal coupled to a bootstrap voltage output terminal of the bootstrap circuit, and a third terminal for outputting a switch control signal. The first switch has a first terminal for receiving an input voltage, a second terminal for receiving the switch control signal, and a third terminal coupled to the bootstrap voltage output terminal. The capacitor is coupled between a voltage switching terminal and the second terminal of the comparator.

### BACKGROUND OF THE INVENTION

1. Field of the Invention

The present invention is related to a bootstrap circuit, and particularly to a bootstrap circuit without a regulator or a diode.

2. Description of the Prior Art

Please refer to FIG. 1. FIG. 1 is a diagram illustrating a bootstrap circuit 100 of the prior art. The bootstrap circuit 100 includes a regulator 102, a diode 104, and a capacitor 106. The diode 104 has an anode coupled to the regulator 102, and a cathode coupled to a bootstrap voltage output terminal BS. The capacitor 106 has a first terminal coupled to the bootstrap voltage output terminal BS, and a second terminal coupled to a voltage switching terminal SW. When a clock CK is at a logic-low voltage (a ground), a voltage VSW of the voltage switching terminal SW is zero (the ground) because the clock CK turns off a switch S1 through a driving circuit 108 and turns on a switch S2 through an inverter 110. Meanwhile, the regulator 102 starts to charge the capacitor 106 through the diode 104, and the regulator 102 does not charge the capacitor 106 until a voltage VBS of the bootstrap voltage output terminal BS is equal to a voltage VR provided by the regulator 102 minus a voltage drop VD of the diode 104.

When the clock CK is at a logic-high voltage, the voltage VSW of the voltage switching terminal SW is the input voltage VIN because the clock CK turns on the switch S1 through the driving circuit 108 and turns off the switch S2 through the inverter 110. Meanwhile, the voltage VBS of the bootstrap voltage output terminal BS is generated according to the following equation (1):

VBS=VIN+VR−VD (1)

As shown in the equation (1), the voltage VBS of the bootstrap voltage output terminal BS is greater than the input voltage VIN. Because the driving circuit 108 can utilize the higher voltage VBS of the bootstrap voltage output terminal BS to turn on the switch S1, the switch S1 can drive a load 112.

However, an area of the regulator 102 and the diode 104 laid out in an integrated circuit is very large and frequency compensation of the regulator 102 is influenced significantly by the capacitor 106. In addition, when the regulator 102 charges the capacitor 106, a voltage stored in the capacitor 106 is lower than the voltage VR, that is to say, the voltage stored in the capacitor 106 is VR−VD.

### SUMMARY OF THE INVENTION

An embodiment provides a bootstrap circuit without a regulator or a diode. The bootstrap circuit includes a comparator, a first switch, and a capacitor. The comparator has a first terminal for receiving a reference voltage, a second terminal coupled to a bootstrap voltage output terminal of the bootstrap circuit, and a third terminal for outputting a switch control signal. The first switch has a first terminal for receiving an input voltage, a second terminal for receiving the switch control signal, and a third terminal coupled to the bootstrap voltage output terminal. The capacitor is coupled between a voltage switching terminal and the second terminal of the comparator.

The present invention provides a bootstrap circuit without a regulator or a diode. The bootstrap circuit substitutes the comparator and the first switch for the regulator and the diode. Therefore, an area of the bootstrap circuit of the present invention laid out in an integrated circuit is more smaller than the bootstrap circuit of the prior art, and the bootstrap circuit of the present invention does not require frequency compensation and does it suffer from a stability issue.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a bootstrap circuit of the prior art.

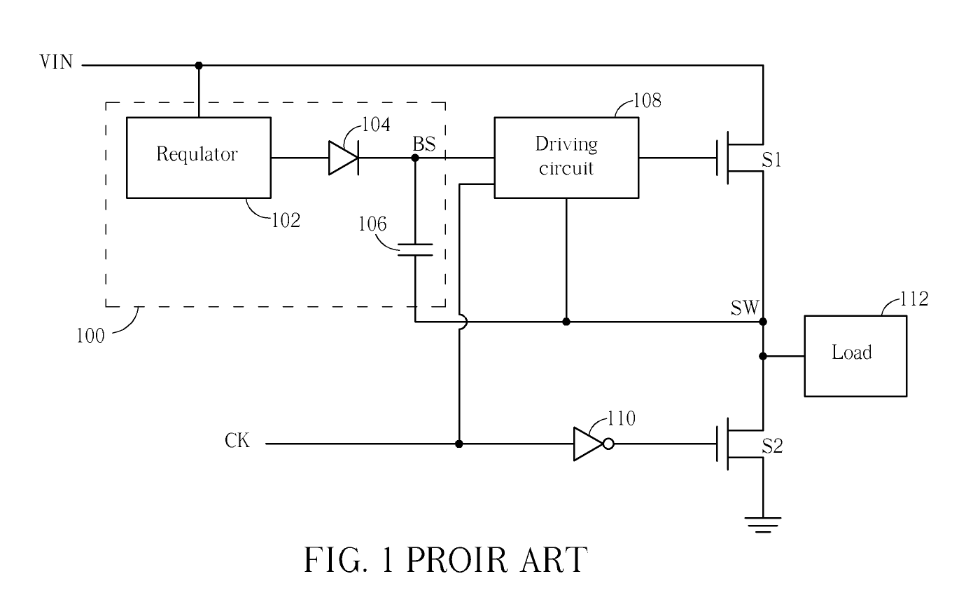

FIG. 2 is a diagram illustrating a bootstrap circuit without a regulator or a diode according to an embodiment.

FIG. 3 is a diagram illustrating a bootstrap circuit without a regulator or a diode according to another embodiment.

FIG. 4 is a diagram illustrating a bootstrap circuit without a regulator or a diode according to another embodiment.

### DETAILED DESCRIPTION

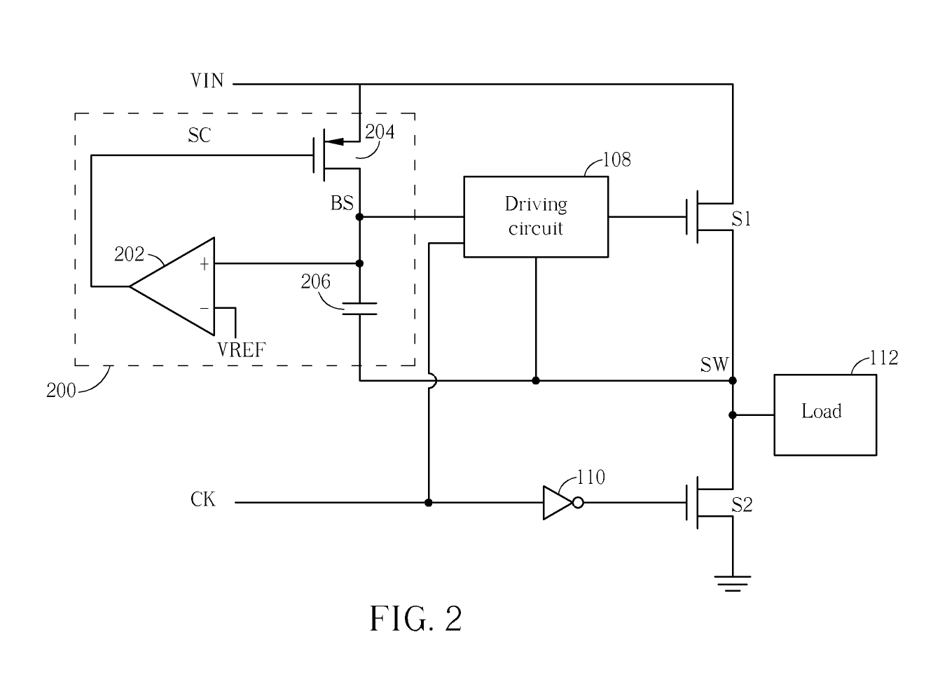

Please refer to FIG. 2. FIG. 2 is a diagram illustrating a bootstrap circuit 200 without a regulator or a diode according to an embodiment. The bootstrap circuit 200 includes a comparator 202, a first switch 204, and a capacitor 206. The comparator 202 has a first terminal for receiving a reference voltage VREF, a second terminal coupled to a bootstrap voltage output terminal BS, and a third terminal for outputting a switch control signal SC. The first switch 204 has a first terminal for receiving an input voltage VIN, a second terminal for receiving the switch control signal SC, and a third terminal coupled to the bootstrap voltage output terminal BS, where the first switch 204 is a P-type metal-oxide-semiconductor, an N-type metal-oxide-semiconductor, or a transmission gate. The capacitor 206 is coupled between a voltage switching terminal SW and the second terminal of the comparator 202. When a clock CK is at a logic-low voltage (a ground), a voltage VSW of the voltage switching terminal SW is zero (the ground) because the clock CK turns off a switch 51 through a driving circuit 108 and turns on a switch S2 through an inverter 110. Meanwhile, the comparator 202 compares a voltage VBS of the bootstrap voltage output terminal BS with the reference voltage VREF. If the voltage VBS is lower than the reference voltage VREF, the comparator 202 outputs the switch control signal SC to the second terminal of the first switch 204 to turn on the first switch 204. The input voltage VIN starts to charge the capacitor 206 through the first switch 204, and the input voltage VIN does not charge the capacitor 206 until the voltage VBS is equal to the reference voltage VREF.

When the clock CK is at a logic-high voltage, the voltage VSW of the voltage switching terminal SW is the input voltage VIN because the clock CK turns on the switch S1 through the driving circuit 108 and turns off the switch S2 through the inverter 110. Meanwhile, the voltage VBS of the bootstrap voltage output terminal BS is generated according to the following equation (2):

VBS=VIN+VREF (2)

As shown in the equation (2), the voltage VBS of the bootstrap voltage output terminal BS is greater than the input voltage VIN. Because the driving circuit 108 can utilize the higher voltage VBS of the bootstrap voltage output terminal BS to turn on the switch S1, the switch S1 can drive a load 112.

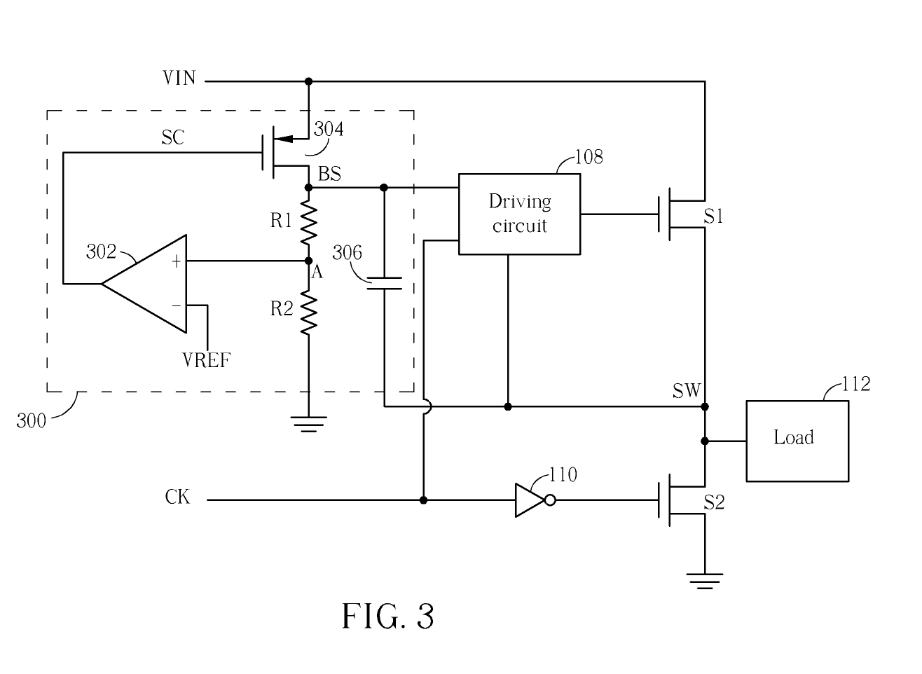

Please refer to FIG. 3. FIG. 3 is a diagram illustrating a bootstrap circuit 300 without a regulator or a diode according to another embodiment. The bootstrap circuit 300 includes a comparator 302, a first switch 304, a capacitor 306, a first voltage dividing resistor R1, and a second voltage dividing resistor R2, where the first voltage dividing resistor R1 is coupled between the bootstrap voltage output terminal BS and a second terminal of the comparator 302, and the second voltage dividing resistor R2 is coupled between the second terminal of the comparator 302 and the ground. When the clock CK is at the logic-low voltage, the input voltage VIN does not charge the capacitor 306 through the first switch 304 until a voltage VA of a node A is equal to the reference voltage VREF. Meanwhile, the voltage VBS of the bootstrap voltage output terminal BS is generated according to the following equation (3):

VBS=VREF*(1+R1/R2) (3)

Therefore, the bootstrap circuit 300 can adjust the voltage VBS of the bootstrap voltage output terminal BS by the first voltage dividing resistor R1 and the second voltage dividing resistor R2. Further, subsequent operational principles of the bootstrap circuit 300 are the same as those of the bootstrap circuit 200, so further description thereof is omitted for simplicity.

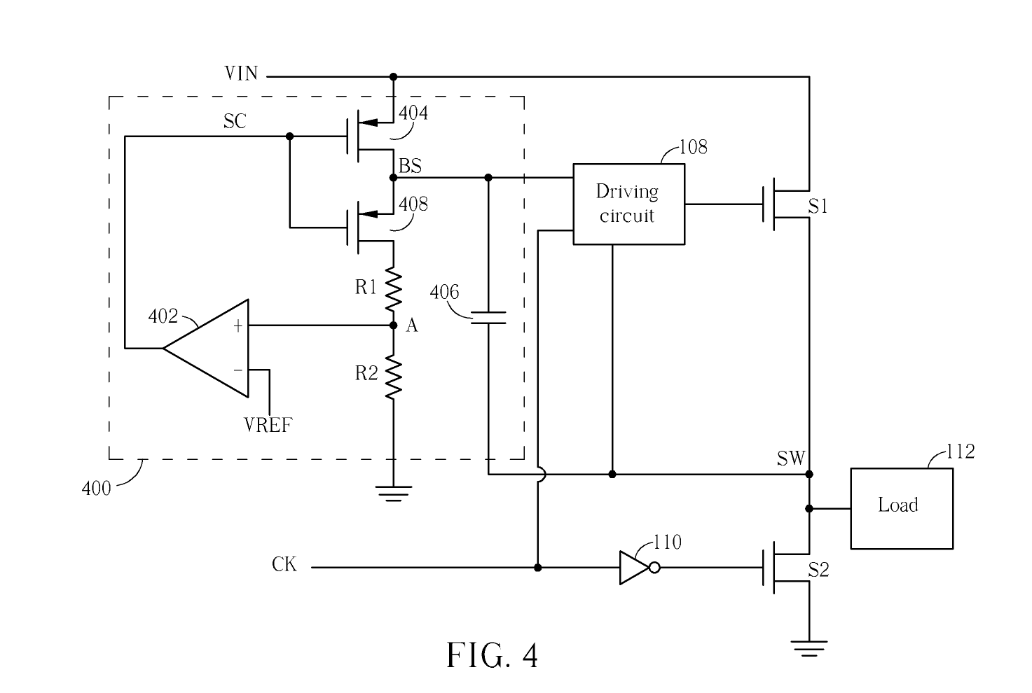

Please refer to FIG. 4. FIG. 4 is a diagram illustrating a bootstrap circuit 400 without a regulator or a diode according to another embodiment. The bootstrap circuit 400 includes a comparator 402, a first switch 404, a capacitor 406, a second switch 408, a first voltage dividing resistor R1, and a second voltage dividing resistor R2, where the first voltage dividing resistor R1 is coupled between a third terminal of the second switch 408 and a second terminal of the comparator 402, the second voltage dividing resistor R2 is coupled between the second terminal of the comparator 402 and the ground, the second switch 408 is coupled between the bootstrap voltage output terminal BS and the first voltage dividing resistor R1, and a second terminal of the second switch 408 is coupled to a third terminal of the comparator 402 to receive the switch control signal SC. Because both the second terminal of the first switch 404 and the second terminal of the second switch 408 receive the switch control signal SC, the first switch 404 and the second switch 408 are turned on or turned off at the same time. In addition, the first switch 404 and the second switch 408 are P-type metal-oxide-semiconductors, N-type metal-oxide-semiconductors, or transmission gates.

When the clock CK is at the logic-low voltage, the input voltage VIN does not charge the capacitor 406 through the first switch 404 and the second switch 408 until the voltage VA of the node A is equal to the reference voltage VREF. Meanwhile, the voltage VBS of the bootstrap voltage output terminal BS is generated according to the equation (3). In addition, when the voltage VA of the node A is equal to the reference voltage VREF, the comparator 402 outputs the switch control signal SC to turn off the first switch 404 and the second switch 408. Because the second switch 408 is turned off, the voltage VBS of the bootstrap voltage output terminal BS is kept at VREF*(1+R1/R2) and not influenced by a leakage current path generated by the first voltage dividing resistor R1 and the second voltage dividing resistor R2. Further, subsequent operational principles of the bootstrap circuit 400 are the same as those of the bootstrap circuit 300, so further description thereof is omitted for simplicity.

To sum up, the bootstrap circuit of the present invention substitutes the comparator and the first switch for the regulator and the diode. Therefore, an area of the bootstrap circuit of the present invention laid out in an integrated circuit is smaller than the bootstrap circuit of the prior art, and the bootstrap circuit of the present invention does not require frequency compensation and neither does it suffer from a stability issue.

Those skilled in the art will readily observe that numerous modifications and alterations of the device and method may be made while retaining the teachings of the invention.

What is claimed is:

1. A bootstrap circuit without a regulator or a diode, the bootstrap circuit comprising:
a comparator having a first terminal for receiving a reference voltage, a second terminal coupled to a bootstrap voltage output terminal of the bootstrap circuit, and a third terminal for outputting a switch control signal;
a first switch having a first terminal for receiving an input voltage, a second terminal for receiving the switch control signal, and a third terminal coupled to the bootstrap voltage output terminal; and
a capacitor coupled between a voltage switching terminal and the second terminal and the comparator.

2. The bootstrap circuit of claim 1, further comprising:
a first voltage dividing resistor coupled between the bootstrap voltage output terminal and the second terminal of the comparator; and
a second voltage dividing resistor coupled between the second terminal of the comparator and a ground.

3. The bootstrap circuit of claim 2, further comprising:
a second switch coupled between the bootstrap voltage output terminal and the first voltage dividing resistor, wherein a second terminal of the second switch is coupled to the third terminal of the comparator to receive the switch control signal.

4. The bootstrap circuit of claim 1, wherein the first switch is a P-type metal-oxide-semiconductor.

5. The bootstrap circuit of claim 1, wherein the first switch is an N-type metal-oxide-semiconductor.

6. The bootstrap circuit of claim 1, wherein the first switch is a transmission gate.

7. The bootstrap circuit of claim 1, wherein the second switch is a P-type metal-oxide-semiconductor.

8. The bootstrap circuit of claim 1, wherein the second switch is an N-type metal-oxide-semiconductor.

9. The bootstrap circuit of claim 1, wherein the second switch is a transmission gate.
